(19) United States
(12) Patent Application Publication
(10) Pub. No.: US 2008/0173746 A1
(43) Pub. Date: Jul. 24, 2008

(54) Magnetic Recording/Reproducing Apparatus

(76) Inventors: Takumi Nishimura, Ehime (JP); Eiichi Mori, Ehime (JP)

Correspondence Address: KRATZ, QUINTOS & HANSON, LLP, 1420 K Street, N.W., Suite 400, WASHINGTON, DC, 20005, US

(21) Appl. No.: 11/662,757

(22) PCT Filed: Sep. 8, 2005
(86) PCT No.: PCT/JP2005/016517

§ 371 Date: Nov. 16, 2007

(30) Foreign Application Priority Data
Sep. 14, 2004 (JP) 2004-266262

(51) Int. Cl. G11B 15/67

(52) U.S. Cl. 242/332.4

(57) ABSTRACT

It is an object of the present invention to provide a magnetic recording/reproducing apparatus in which a step on an outer peripheral surface of a reel hub is eliminated and a tape is not damaged. In a magnetic recording/reproducing apparatus, an end of a tape accommodated in a tape cassette has a coupling element 8, and the coupling element 8 is pulled out by a tape-pulling-out element 40 and the tape is taken up around a drive reel 20. The magnetic recording/reproducing apparatus comprises a leader tape 41 having one end connected to a drive shaft 24 of the drive reel 20 and the other end connected to the tape-pulling-out element 40, a reel hub 21 which is located on an outer periphery of the drive shaft 24 and which takes up the tape around an outer peripheral surface of the reel hub 21, a hub opening which is provided on a portion of the reel hub 21 and through which the leader tape 41 passes, and a positioning piece 80 which is located in the hub opening and which positions the tape-pulling-out element 40. The reel hub 21 is made of metal material, and the positioning piece 80 is made of resin material.

### TECHNICAL FIELD

The present invention relates to a magnetic recording/reproducing apparatus which pulls out an end of a tape from a tape cassette of a single hub having one reel around which a tape is wound, and which winds the tape around a drive reel, and which carries out recording and replaying operations.

### BACKGROUND TECHNIQUE

In some conventional magnetic recording/reproducing apparatuses of this kind, only a leader tape is introduced into a reel hub, a tape-pulling-out element is stopped at an opening position of the reel hub, thereby carrying out a tape threading operation. In this case, it is proposed to match with a shape of an outer periphery of the reel hub (e.g., patent document 1).

[Patent Document 1]

Japanese Patent Application Laid-open No. 2002-530792 (paragraph No. (0037), FIG. 11)

However, in the conventional apparatus, since the reel hub is made of resin material, variation in size precision from the winding reel hub is increased, a deviation in the radial direction is generated, an outer periphery area of the tape-pulling-out element occupies a great ratio with respect to an outer periphery area of the reel hub, it becomes difficult to establish a tangent relation, and a step is easily be produced between the outer peripheral shape of the winding reel hub. Such step at the outer peripheral surface of the reel hub damages a tape.

Hence, it is an object of the present invention to provide a magnetic recording/reproducing apparatus in which a step on an outer peripheral surface of a reel hub is eliminated and a tape is not damaged.

### DISCLOSURE OF THE INVENTION

A first aspect of the present invention provides a magnetic recording/reproducing apparatus in which an end of a tape accommodated in a tape cassette has a coupling element, and the coupling element is pulled out by a tape-pulling-out element and the tape is taken up around a drive reel, the magnetic recording/reproducing apparatus comprising a leader tape having one end connected to a drive shaft of the drive reel and the other end connected to the tape-pulling-out element, a reel hub which is located on an outer periphery of the drive shaft and which takes up the tape around an outer peripheral surface of the reel hub, a hub opening which is provided on a portion of the reel hub and through which the leader tape passes, and a positioning piece which is located in the hub opening and which positions the tape-pulling-out element, wherein the reel hub is made of metal material, and the positioning piece is made of resin material.

According to a second aspect of the invention, in the first aspect, the hub opening is provided at its side with a reference surface recess formed by cutting the reel hub from its inner peripheral surface toward its outer peripheral surface, and the positioning piece is disposed in the reference surface recess.

According to a third aspect of the invention, in the second aspect, the reference surface recess constitutes a reference surface in an outer peripheral direction for limiting a distance from the outer peripheral surface of the reel hub.

According to a fourth aspect of the invention, in the third aspect, the positioning piece includes a reference surface corresponding to the reference surface in the outer peripheral direction, a side surface of the positioning piece on the side of opening which is perpendicular to the reference surface is formed with a rib or a groove having a predetermined length, and the rib or the groove is orientated in an inserting direction of the tape-pulling-out element.

According to a fifth aspect of the invention, in the first aspect, the positioning piece is formed with a rib or a groove having a predetermined length, the rib or the groove is orientated in an inserting direction of the tape-pulling-out element, and the tape-pulling-out element is formed at its side surface with a groove or a rib which corresponds to the rib or the groove.

According to a sixth aspect of the invention, in the fifth aspect, the tape-pulling-out element is provided at its side surface with a stop wall which abuts against the positioning piece.

According to a seventh aspect of the invention, in the first aspect, the tape-pulling-out element includes a first member formed with a recess, and a second member connected to the first member such that the second member can be displaced, the second member includes a lid plate on which the coupling element is mounted by closing the recess, an outer peripheral surface of the lid plate is formed with a curved surface, the curved surface has the same curvature as that of the outer peripheral surface of the reel hub, and the curved surface constitutes a portion of the outer peripheral surface of the reel hub in a state in which the tape-pulling-out element is fitted into the hub opening.

According to the present invention, a coupling element is reliably held, a tape threading operation is stably carried out, and a tape is not damaged.

### BRIEF DESCRIPTION OF THE DRAWINGS

FIG. 1 is a plan view of an essential portion of a magnetic recording/reproducing apparatus according to an embodiment of the present invention;

FIG. 2 is a plan view of an essential portion of the apparatus;

FIG. 3 is a plan view of the essential portion of the apparatus;

FIG. 4 is a plan view of the essential portion of the apparatus;

FIG. 5 is a plan view of the essential portion of the apparatus;

FIG. 6 is a plan view of the essential portion of the apparatus;

FIG. 7 is a plan view of the essential portion of the apparatus;

FIG. 8 is a plan view of the essential portion of the apparatus;

FIG. 9 is a sectional view of an upper surface showing an essential portion of a drive reel of an embodiment;

FIG. 10 is a sectional view of the upper surface showing the essential portion of the drive reel of the embodiment;

FIG. 11 is a sectional view of the upper surface showing the essential portion of the drive reel of the embodiment;

FIG. 12 is an exploded perspective view of the drive reel of the embodiment

FIG. 13 is a perspective view of a positioning piece of the embodiment;

FIG. 14 is a perspective view of a periphery of a hub opening of the embodiment in a state where the positioning piece is detached;

FIG. 15 is a perspective view showing a state where the positioning piece is disposed;

FIG. 16 is a perspective view of a tape-pulling-out element; and

FIG. 17 is a perspective view of FIG. 16 as viewed from a different angle.

### BEST MODE FOR CARRYING OUT THE INVENTION

The magnetic recording/reproducing apparatus of the first aspect of the invention comprises a leader tape having one end connected to a drive shaft of the drive reel and the other end connected to the tape-pulling-out element, a reel hub which is located on an outer periphery of the drive shaft and which takes up the tape around an outer peripheral surface of the reel hub, a hub opening which is provided on a portion of the reel hub and through which the leader tape passes, and a positioning piece which is located in the hub opening and which positions the tape-pulling-out element. The reel hub is made of metal material, and the positioning piece is made of resin material. With this aspect, the reel hub is made of metal material which can easily be machined, and the positioning piece is made of resin material. With this, the size precision from the center of the reel hub is not varied, and deviation between the reel hub and the tape-pulling-out element in the radial direction can be reduced.

According to the second aspect of the invention, in the magnetic recording/reproducing apparatus of the first aspect, the hub opening is provided at its side with a reference surface recess formed by cutting the reel hub from its inner peripheral surface toward its outer peripheral surface, and the positioning piece is disposed in the reference surface recess. With this aspect, the reference recess for disposing the positioning piece is formed by cutting the reel hub from its inner peripheral surface toward its outer peripheral surface. With this, the reference surface can be formed near the reel hub, and the positioning precision can be enhanced.

According to the third aspect of the invention, in the magnetic recording/reproducing apparatus of the second aspect, the reference surface recess constitutes a reference surface in an outer peripheral direction for limiting a distance from the outer peripheral surface of the reel hub. With this aspect, a deviation between the reel hub and the tape-pulling-out element in the radial direction can be reduced by the reference surface in the outer peripheral direction.

According to the fourth aspect of the invention, in the magnetic recording/reproducing apparatus of the third aspect, the positioning piece includes a reference surface corresponding to the reference surface in the outer peripheral direction, a side surface of the positioning piece on the side of opening which is perpendicular to the reference surface is formed with a rib or a groove having a predetermined length, and the rib or the groove is orientated in an inserting direction of the tape-pulling-out element. With this aspect, the tape-pulling-out element can stably be guided to a predetermined position by the rib or the groove having a predetermined length formed on or in the positioning piece.

According to the fifth aspect of the invention, in the magnetic recording/reproducing apparatus of the first aspect, the positioning piece is formed with a rib or a groove having a predetermined length, the rib or the groove is orientated in an inserting direction of the tape-pulling-out element, and the tape-pulling-out element is formed at its side surface with a groove or a rib which corresponds to the rib or the groove. With this aspect, the tape-pulling-out element can be guided to a predetermined position stably by the rib or the groove having a predetermined length formed on or in the positioning piece and the tape-pulling-out element.

According to the sixth aspect of the invention, in the magnetic recording/reproducing apparatus of the fifth aspect, the tape-pulling-out element is provided at its side surface with a stop wall which abuts against the positioning piece. With this aspect, sizes of the reel hub and the tape-pulling-out element in the radial direction can match with each other by this stop wall.

According to the seventh aspect of the invention, in the magnetic recording/reproducing apparatus of the first aspect, the tape-pulling-out element includes a first member formed with a recess, and a second member connected to the first member such that the second member can be displaced, the second member includes a lid plate on which the coupling element is mounted by closing the recess, an outer peripheral surface of the lid plate is formed with a curved surface, the curved surface has the same curvature as that of the outer peripheral surface of the reel hub, and the curved surface constitutes a portion of the outer peripheral surface of the reel hub in a state in which the tape-pulling-out element is fitted into the hub opening. With this aspect, a curved surface shape having the same curvature as that of the outer peripheral surface of the reel hub is formed by the lid plate of the second member. With this, influence of distortion or bending by the resin material can be reduced.

A magnetic recording/reproducing apparatus of an embodiment of the present invention will be explained below.

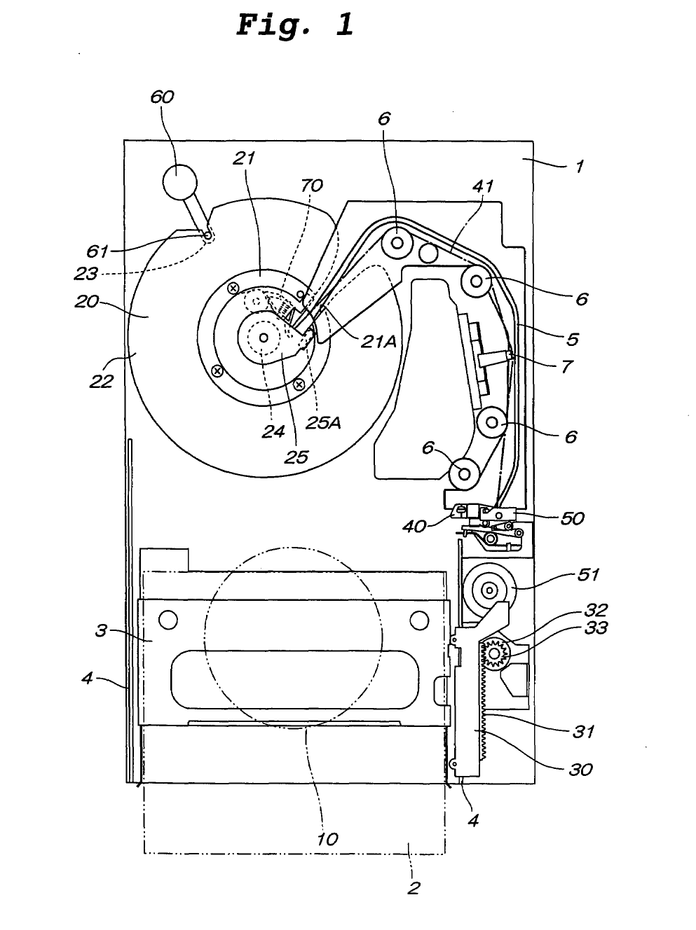

FIG. 1 is a plan view of an essential portion of the magnetic recording/reproducing apparatus of the embodiment.

A base 1 of an apparatus main body includes a cartridge reel 10 having rotating means such as a motor, and a drive reel 20 having another rotating means. A cassette holder 3 which holds the tape cassette 2 and which moves the tape cassette 2 is provided on the side of the cartridge reel 10 of the base 1. A pair of rails 4 is disposed on the side of the cartridge reel 10 of the base 1, and the cassette holder 3 is provided such that the cassette holder 3 can slide along the pair of rails 4.

A loading lever 30 is slidably provided on one of the rails 4. The loading lever 30 is connected to the cassette holder 3, and the cassette holder 3 is operated by movement of the loading lever 30.

A rack 31 is connected to a surface of the loading lever 30 on the side of the base 1. A loading motor 32 and a gear 33 connected to the loading motor 32 are disposed on the side of the loading lever 30. The rack 31 and the gear 33 mesh with each other, and the loading lever 30 slides along the rails 4 by rotation of the loading motor 32.

A tape-pulling-out element 40 is disposed on the side of the tape cassette 2, that is, disposed in the vicinity of a door (not shown) of the tape cassette 2, when the loading operation is completed. The tape-pulling-out element 40 is held by a tape-pulling-out element moving member 50. The tape-pulling-out element moving member 50 is engaged with a groove (not shown) provided in a direction moving toward and away from a door of the tape cassette 2. A tape-pulling-out element moving motor 51 is disposed in a space between the loading motor 32 and the tape-pulling-out element 40 on the side of the loading lever 30. The tape-pulling-out element moving member 50 is connected to the tape-pulling-out element moving motor 51 through a gear mechanism (not shown).

Track grooves 5 are formed between positions in the vicinity of the tape-pulling-out element 40 and a reel hub 21 of a drive reel 20. Although only the track groove 5 on the side of the base 1 is shown in FIG. 1, another track groove having the same shape is also formed in a member (not shown) disposed at a predetermined distance from the former track groove 5, and the tape-pulling-out element 40 is guided by the pair of track grooves 5. A plurality of rollers 6 and a magnetic head 7 are disposed on the side of the track groove 5. In a state shown in the drawing, a reader tape 41 is disposed along the track groove 5. One end of the reader tape 41 is connected to the Drive reel 20, and the other end of the reader tape 41 is connected to the tape-pulling-out element 40.

The drive reel 20 includes a reel flange 22. The reel flange 22 is formed at its outer peripheral end with a flange groove 23. Although only the reel flange 22 on the side of the base 1 is shown in the drawing, a pair of reel flanges 22 is connected to both end surfaces of the reel hub 21. A hub opening 21A is formed in a portion of an outer periphery of the reel hub 21, and the reader tape 41 passes through the hub opening 21A. The tape-pulling-out element 40 is fitted into the hub opening 21A. The drive reel 20 is provided at its center with a drive shaft 24 which transmits rotation of the rotating means such as the motor. The connection of the drive shaft 24 with respect to the reel hub 21 and the reel flange 22 is released by the lock member 70 at the time of tape threading motion, and drive shaft 24 is connected to the reel hub 21 and the reel flange 22 at the time of recording and replaying operations. The reel hub 21 is provided at its end surface with a magnet holding member 25. A magnet 25A is disposed in the vicinity of the hub opening 21A in the reel hub 21 by this magnet holding member 25.

A lock motor 60 and a pin 61 which moves into the flange groove 23 by the rotation of the lock motor 60 are disposed on the side of the outer periphery of the reel flange 22 on the side of the base 1.

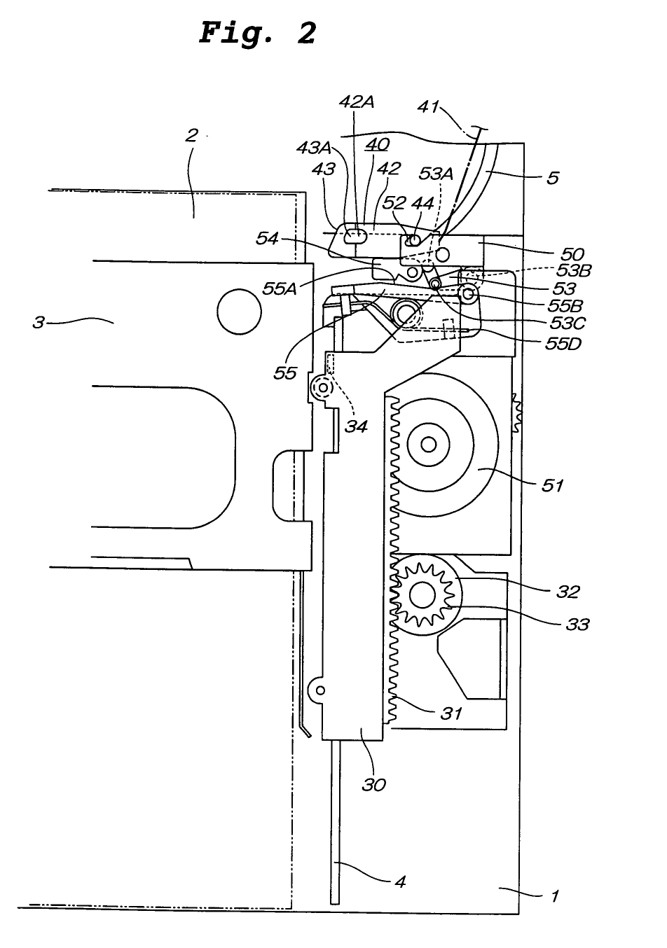

Next, a structure around the tape-pulling-out element moving member 50 will be explained in detail using FIG. 2.

First, the tape-pulling-out element 40 includes a first member 42 forming a recess 42A, and a second member 43 connected to the first member 42 such that the second member 43 can be displaced. The first member 42 is provided at its one end with a turning shaft 44 which turns the second member 43. The recess 42A is formed in the other end of the first member 42. Both ends of the turning shaft 44 project into the track grooves 5, so that the turning shaft 44 can slide along the track grooves 5. The second member 43 is formed with a recess 43A, and the recess 42A of the first member 42 and the recess 43A of the second member 43 form a closed space.

The tape-pulling-out element moving member 50 includes a turning shaft recess 52 with which the turning shaft 44 is engaged. The turning shaft recess 52 is continuous with an end of the track groove 5 at a predetermined position of the tape-pulling-out element moving member 50. The tape-pulling-out element moving member 50 includes a press member 53 and a support member 54. The press member 53 is provided at its one end with a press rib 53A which presses the second member 43 on the side of the turning shaft 44, and at its other end with a shaft 53B which functions as a turning fulcrum of the press rib 53A, and at its intermediate portion with a roller pin 53C. The support member 54 supports the first member 42, and prevents the tape-pulling-out element 40 from rotating when the second member 43 on the side of the turning shaft 44 is pressed by the press rib 53A. The support member 54 is provided at its lower surface with a pin, and if the pin slides in the groove, this exhibits a guide function when the tape-pulling-out element moving member 50 moves toward and away from the tape cassette 2. At a position where the tape-pulling-out element moving member 50 is most separated from the tape cassette 2, the support member 54 turns in the counterclockwise direction through a predetermined angle, thereby turning the tape-pulling-out element 40 in the counterclockwise direction. Thus, the support member 54 moves the tape-pulling-out element 40 into the groove 5 smoothly.

A guider 55 is disposed between the tape-pulling-out element moving member 50 and the loading lever 30. The guider 55 is formed with a guide surface 55A formed on its side on the side of the tape-pulling-out element moving member 50. The guide surface 55A limits movement of the roller pin 53C. The guider 55 can turn through a predetermined angle around the rotation shaft 55B. The guider 55 is biased toward the loading lever 30 by the elastic member 55D.

The loading lever 30 is provided at its end on the side of the guider 55 with a press member 34. The press member 34 presses the elastic member 55D by moving the loading lever 30 toward the tape-pulling-out element moving member 50. If the elastic member 55D is pressed by the press member 34, a free end of the guider 55 moves toward the tape-pulling-out element moving member 50.

The tape threading motion will be explained using FIGS. 1 to 8.

FIG. 1 shows a state of the tape cassette 2 before loading.

If this apparatus detects the insertion of the tape cassette 2 into the cassette holder 3, the loading motor 32 starts rotating. The rotation of the loading motor 32 is transmitted to the loading lever 30 by the gear 33 and the rack 31, and the loading lever 30 moves toward the tape-pulling-out element 40. The cassette holder 3 moves together with the loading lever 30. If the tape cassette 2 moves to a position above the cartridge reel 10, a portion of the cassette holder 3 moves the tape cassette 2 toward the base 1, and drive teeth (not shown) provided on a back surface of the tape cassette 2 are engaged with the cartridge reel 10.

By engaging the tape cassette 2 with the cartridge reel 10, the loading motion is completed. FIG. 2 shows a position of the loading lever 30 in this state. In a state where the loading of the tape cassette 2 is completed, the door of the tape cassette 2 is opened. The end of the tape accommodated in the tape cassette 2 is provided with the connection element (not shown), and this connection element is guided to a location near the door.

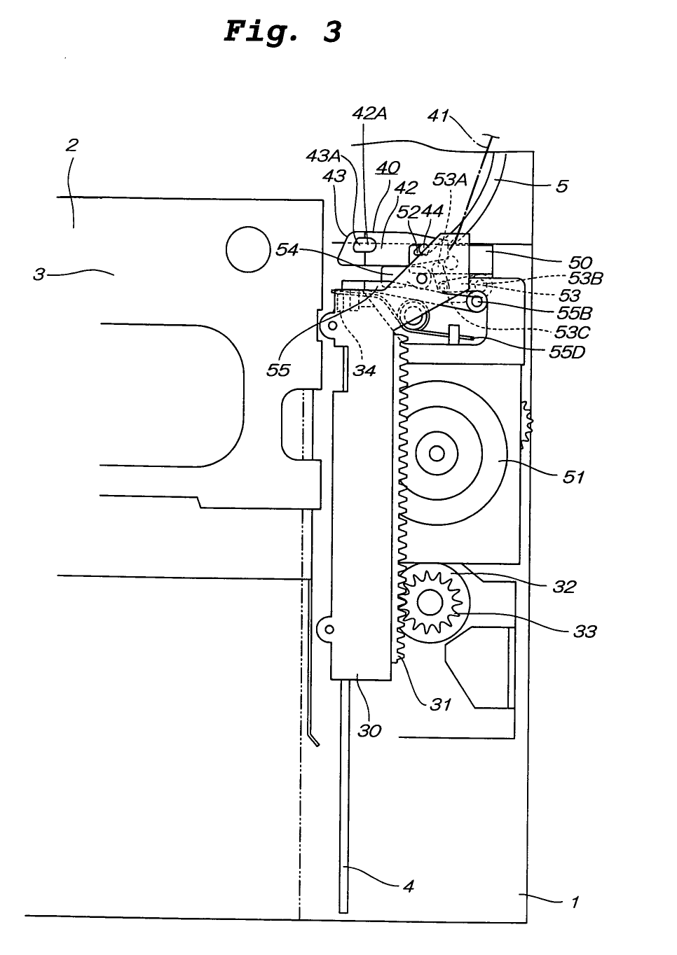

The loading lever 30 is moved to a location shown in FIG. 3 from the state shown in FIG. 2 which shows the state where the loading operation of the tape cassette 2 is completed. The loading motor 32 moves the loading lever 30 to the position shown in FIG. 3 and is stopped.

In the state shown in FIG. 3, the press member 34 of the loading lever 30 pushes the elastic member 55D, and a free end of the guider 55 is moved toward the tape-pulling-out element moving member 50. If the guider 55 moves, the position of the roller pin 53C is limited by the guide surface 55A.

The tape-pulling-out element moving motor 51 starts driving from the state shown in FIG. 3. If the tape-pulling-out element moving motor 51 is driven, the tape-pulling-out element moving member 50 is moved toward the tape cassette 2.

If the tape-pulling-out element moving member 50 is moved, the roller pin 53C is moved along the guide surface 55A. As the roller pin 53C approaches the tape cassette 2, the guide surface 55A approaches the tape-pulling-out element moving member 50 and thus, the roller pin 53C approaches the tape-pulling-out element moving member 50. If the roller pin 53C is displaced, the press rib 53A moves toward the tape-pulling-out element 40. The press rib 53A presses the side of the second member 43. If the press rib 53A presses the second member 43, the second member 43 turns around the turning shaft 44. The recess 43A of the second member 43 moves away from the recess 42A of the first member 42 and the recess 42A is opened.

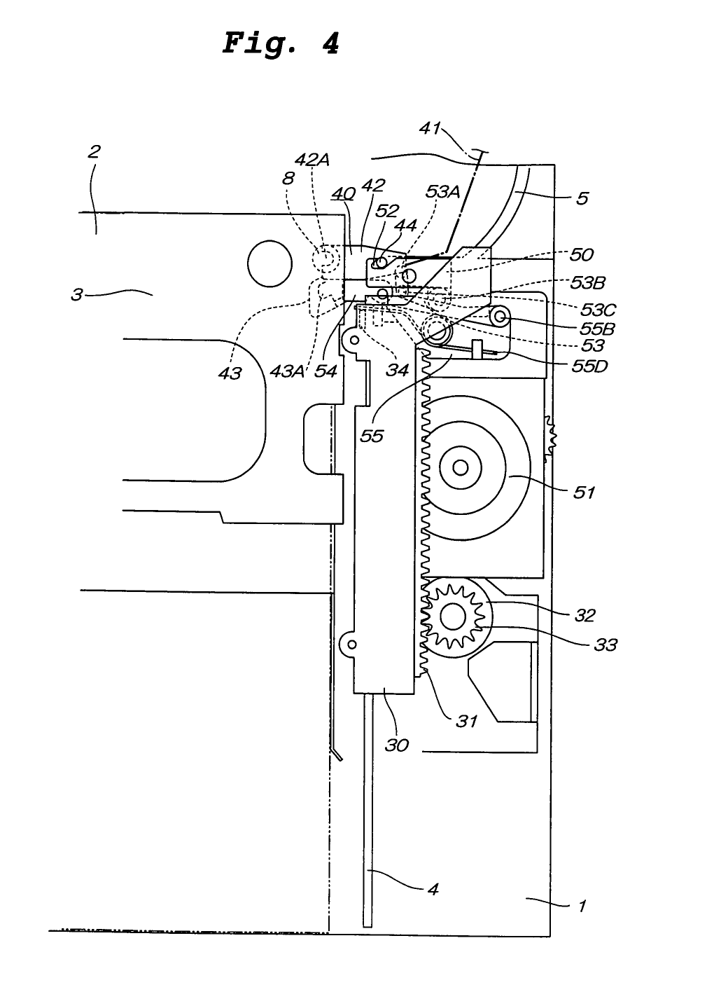

The tape-pulling-out element moving motor 51 moves the tape-pulling-out element moving member 50 and stops until the recess 42A of the first member 42 of the tape-pulling-out element 40 is inserted into the cassette 2. FIG. 4 shows this state.

In the state shown in FIG. 4, the recess 42A of the first member 42 is abutted against the connection element 8.

From the state shown in FIG. 4, the loading motor 32 is driven by reverse rotation, and the loading lever 30 is retreated. If the loading lever 30 is retreated, the pressing force of the press member 34 of the loading lever 30 against the guider 55 is released. Therefore, since the free end of the guider 55 moves toward the loading lever 30, the pressing force of the press rib 53A against the second member 43 is released. Since the pressing force of the press rib 53A against the second member 43 is released, the second member 43 turns around the turning shaft 44, the recess 43A of the second member 43 approaches the recess 42A of the first member 42 and the recess 42A is closed. Next, the tape-pulling-out element moving motor 51 starts driving by reverse rotation. By reversely rotating the tape-pulling-out element moving motor 51, the tape-pulling-out element moving member 50 starts moving away from the tape cassette 2.

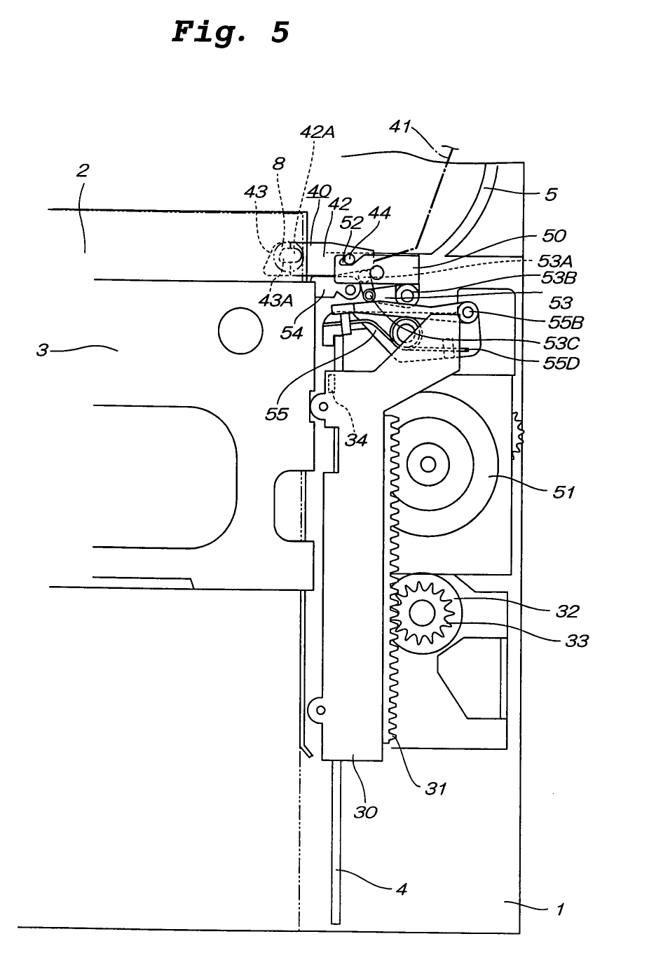

Therefore, the connection element 8 is disposed in a closed space formed by the recess 42A of the first member 42 and the recess 43A of the second member 43. That is, the connection element 8 is sandwiched and held between the recess 42A of the first member 42 and the recess 43A of the second member 43. FIG. 5 shows this state.

From the state shown in FIG. 5, the tape-pulling-out element moving motor 51 keeps driving by the reverse rotation. If the tape-pulling-out element moving motor 51 keeps driving by the reverse rotation, the tape-pulling-out element moving member 50 further moves away from the tape cassette 2.

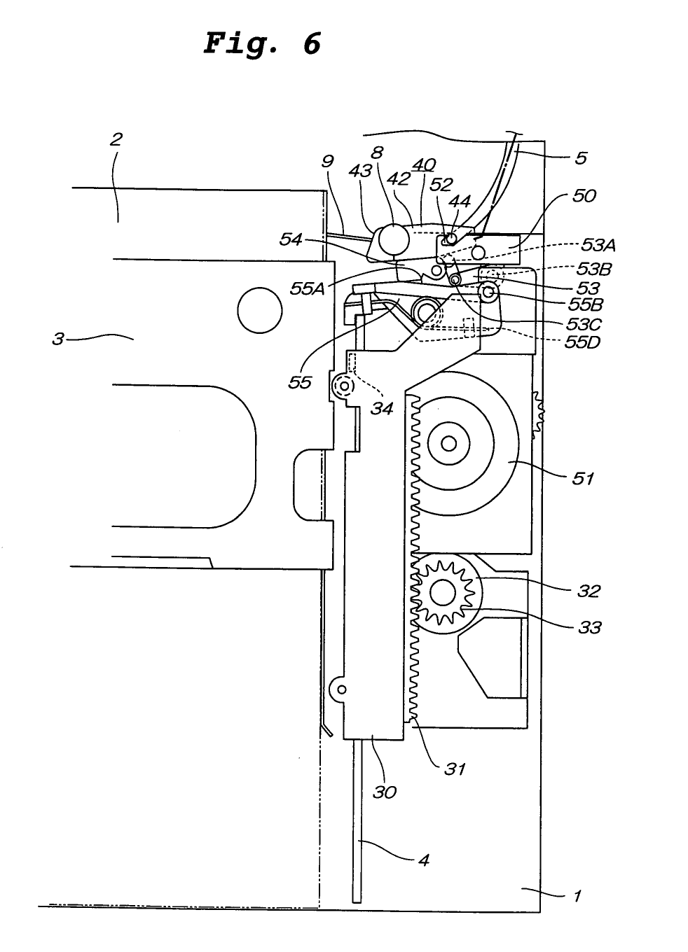

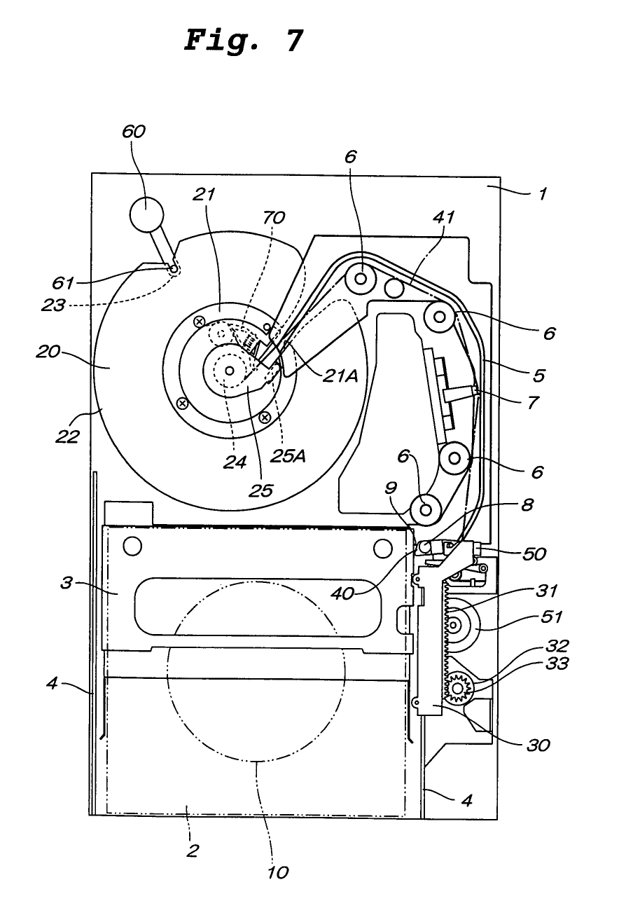

FIGS. 6 and 7 show a state where the movement of the tape-pulling-out element moving member 50 away from the tape cassette 2 is completed. As shown in FIG. 6, a tape 9 accommodated in the tape cassette 2 is pulled out together with the connection element 8. In a state where the movement of the tape-pulling-out element moving member 50 away from the tape cassette 2 is completed, the turning shaft recess 52 is in a position continuous with the end of the track groove 5. In this position, the support member 54 is turned in the counterclockwise direction through a predetermined angle, thereby turning the tape-pulling-out element 40 in the counterclockwise direction, and the tape-pulling-out element 40 smoothly moves toward the groove 5.

From the state shown in FIGS. 6 and 7, the tape threading motion is started.

The tape threading motion is carried out by rotating the drive reel 20. At the time of the tape threading motion, the reel hub 21 is released from a drive system of the drive reel 20, and rotation of the reel hub 21 is limited by the pin 61.

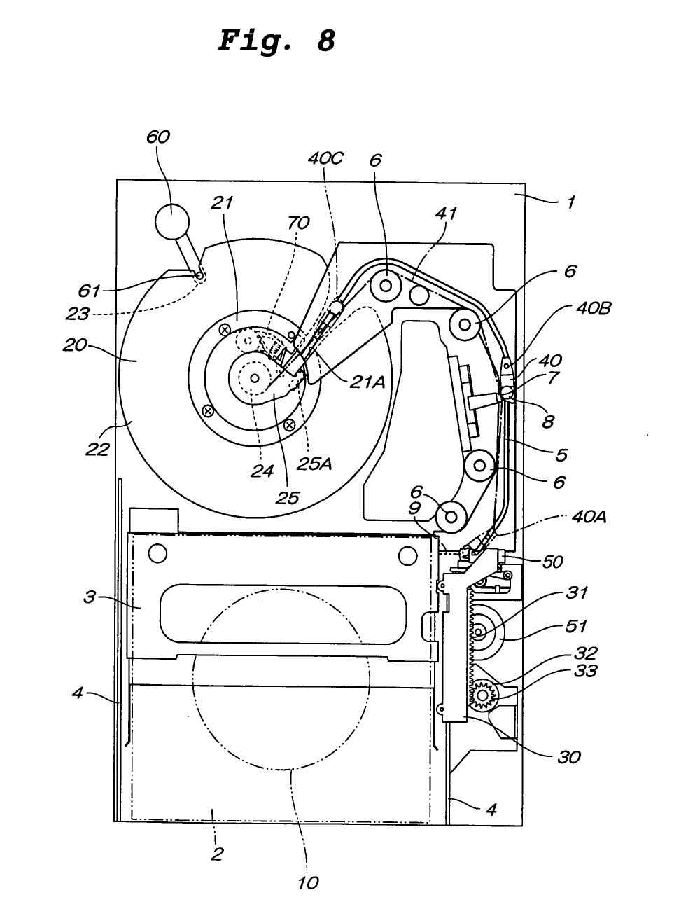

The reader tape 41 is reeled up around the drive shaft of the drive reel 20 by the rotation of the drive reel 20. By the reeling up motion of the reader tape 41 around the drive shaft of the drive reel 20, the tape-pulling-out element 40 is pulled by the reader tape 41. Therefore, the both ends of the turning shaft 44 of the tape-pulling-out element 40 move toward the track grooves 5 from the turning shaft recess 52, and slide in the track grooves 5. FIG. 8 shows this state.

FIG. 8 shows a state where the turning shaft 44 of a tape-pulling-out element 40A moves from the turning shaft recess 52 to the track groove 5, a tape-pulling-out element 40B moves to an intermediate portion of the track groove 5, and a tape-pulling-out element 40C moves to a location close to the reel hub 21 of the drive reel 20. By sequentially moving the tape-pulling-out element like the tape-pulling-out element 40A, the tape-pulling-out element 40B and the tape-pulling-out element 40C, the tape 9 accommodated in the tape cassette 2 can be pulled out and introduced to the reel hub 21.

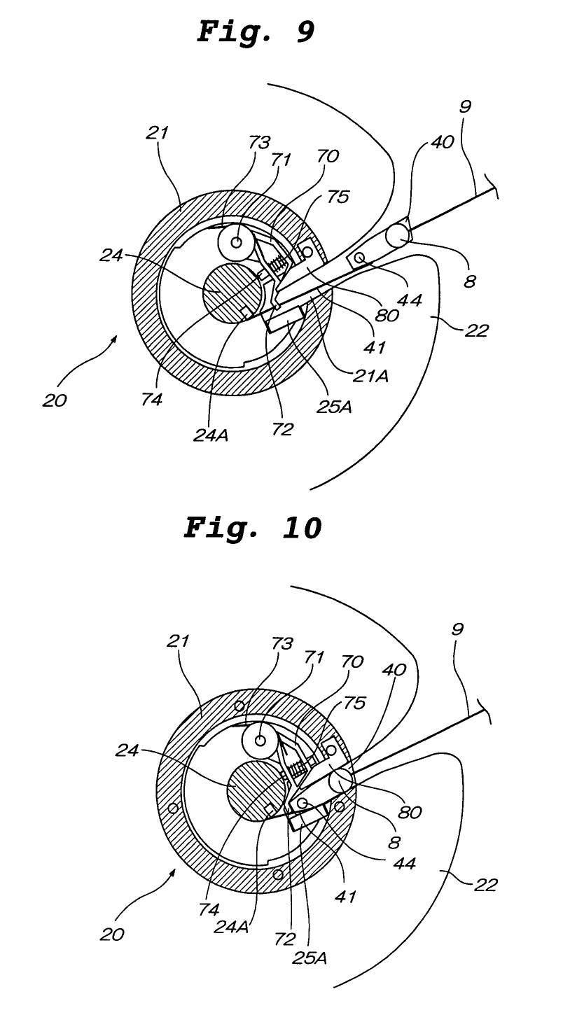

FIGS. 9 to 11 show action after the tape-pulling-out element 40 reaches the drive reel 20. FIGS. 9 to 11 are sectional views of an upper surface showing an essential portion of the drive reel 20.

First, before explaining the action, a structure in the reel hub 21 will be explained using FIGS. 9 to 12. FIG. 12 is an exploded perspective view of the drive reel.

A lock member 70 is provided in a space between the drive shaft 24 and the reel hub 21.

The lock member 70 includes a lock member rotation shaft 71 provided on the reel hub 21, an element abutment portion 72 which is turned around the lock member rotation shaft 71 through a predetermined angle, a biasing member 73 which biases the element abutment portion 72 toward the hub opening 21A, and a lock pin 74 projects in the axial direction of the drive shaft 24. Here, the lock pin 74 is provided on a member main body extending from the lock member rotation shaft 71 to the element abutment portion 72, and is biased in the axial direction of the drive shaft 24 by a spring 75.

The drive shaft 24 is provided at its outer periphery with a fitting hole 24A into which the lock pin 74 can be inserted. As shown in FIG. 12, the drive shaft 24 is provided at its end with a connection shaft 24B. The connection shaft 24B is fastened to the reel hub 21. In a state where the lock pin 74 is inserted into the fitting hole 24A, the connection shaft 24B is connected to the drive shaft 24 and is rotated in unison with the drive shaft 24, but in a state where the lock pin 74 is not inserted into the fitting hole 24A, the connection with respect to the drive shaft 24 is released, and the rotation of the drive shaft 24 is not transmitted.

The hub opening 21A is provided with a positioning piece 80 which is a separate member from the reel hub 21. The tape-pulling-out element 40 is guided to a predetermined position by the positioning piece 80 and is fixed to the position.

Action after the tape-pulling-out element 40 reaches the drive reel 20 will be explained using FIGS. 9 to 11.

FIG. 9 shows a state before the tape-pulling-out element 40 reaches the hub opening 21A.

In the state shown in FIG. 9, the element abutment portion 72 is biased toward the hub opening 21A by the biasing member 73, and the lock pin 74 is separated from the drive shaft 24.

If the leader tape 41 is reeled up into the reel hub 21, the tape-pulling-out element 40 is pulled into the hub opening 21A. The tape-pulling-out element 40 which was pulled into the hub opening 21A is attracted by the magnet 25A, and the reeling up operation of the leader tape 41 is completed. This state is shown in FIG. 10.

In the state shown in FIG. 10, the element abutment portion 72 turns around the lock member rotation shaft 71 through a predetermined angle, and the element abutment portion 72 is displaced from the hub opening 21A toward the drive shaft 24. The lock pin 74 is biased toward the drive shaft 24 by the displacement of the element abutment portion 72. In this state, the tape-pulling-out element 40 closes the hub opening 21A, and a terminal end surface of the tape-pulling-out element 40, i.e., an end surface of the tape-pulling-out element 40 to which the coupling element 8 is mounted is disposed such that it is continuous with the outer peripheral surface of the reel hub 21.

The above-described action is carried out by normal rotation of the drive shaft 24.

If it is detected that the tape-pulling-out element 40 closes the hub opening 21A, the rotation of the drive shaft 24 is stopped. The lock pin 74 is inserted into the fitting hole 24A by reversely rotating the drive shaft 24 through a predetermined angle. It is preferable that the drive shaft 24 is reversely rotated in a range of rotation angle of 90 to 120°.

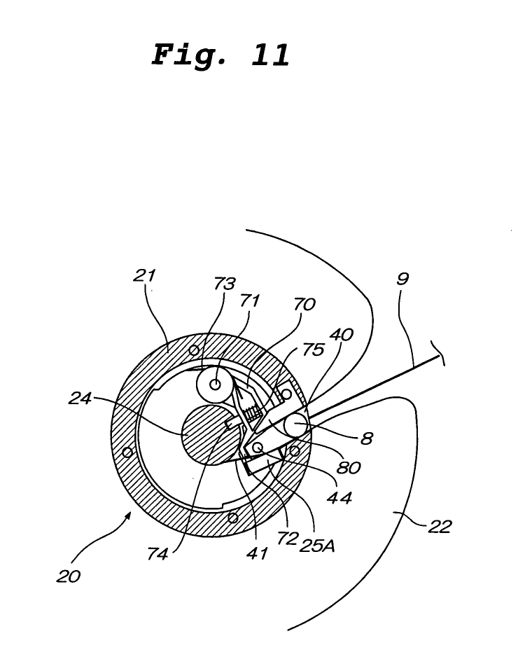

In the state shown in FIG. 11, the connection shaft 24B is connected to the drive shaft 24 and is rotated in unison with the drive shaft 24. As shown in FIG. 11, if the lock pin 74 is inserted into the fitting hole 24A, the rotation of the drive shaft 24 is stopped.

If the connection shaft 24B and the drive shaft 24 are connected to each other, the drive shaft 24 is connected to the reel hub 21 and the reel flange 22.

If the drive shaft 24 is connected to the reel hub 21 and the reel flange 22, the lock motor 60 is operated, and the pin 61 retreats from the flange groove 22.

With the above action, the tape threading operation is completed.

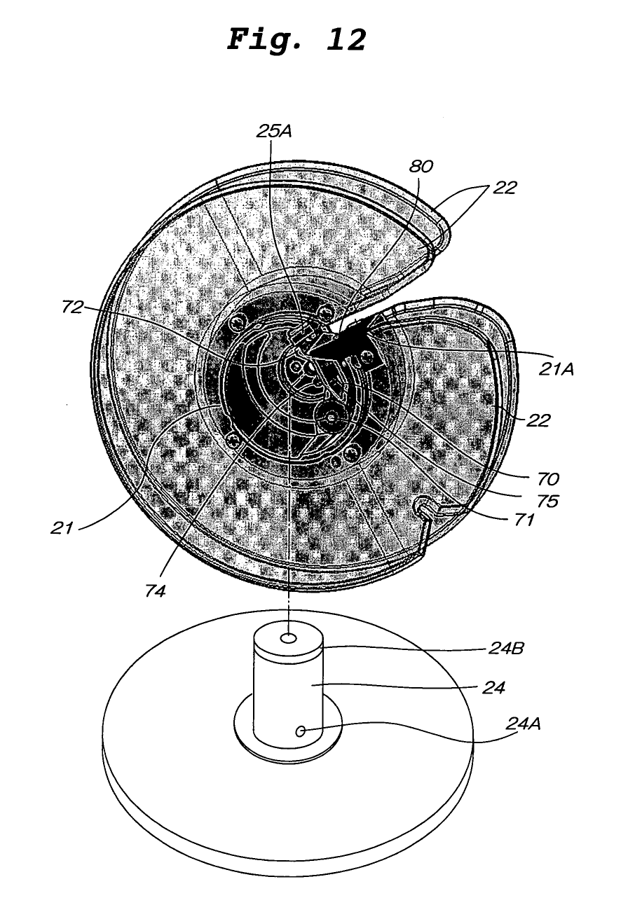

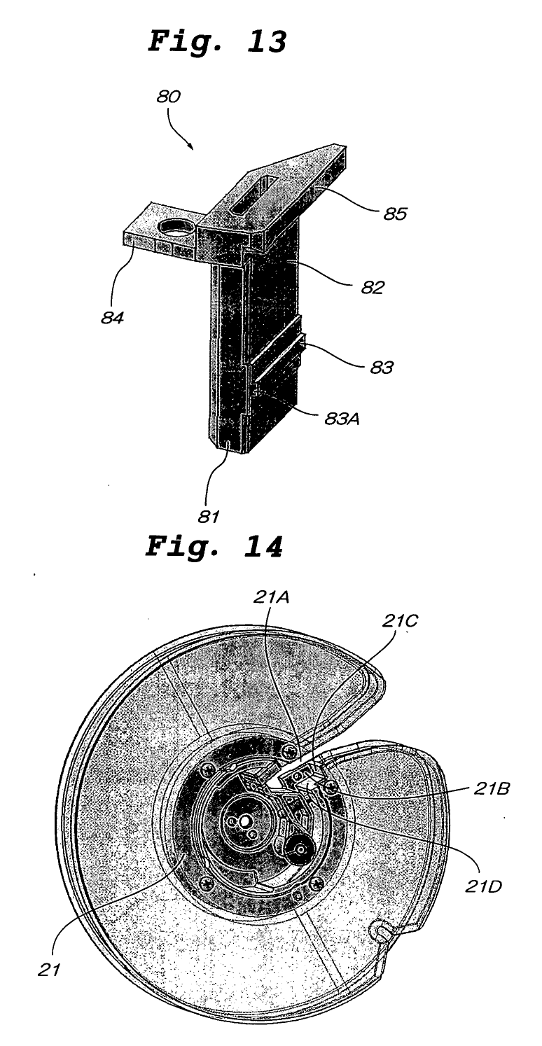

Next, a structure of a periphery of the hub opening according to the embodiment will be explained using FIGS. 13 to 15.

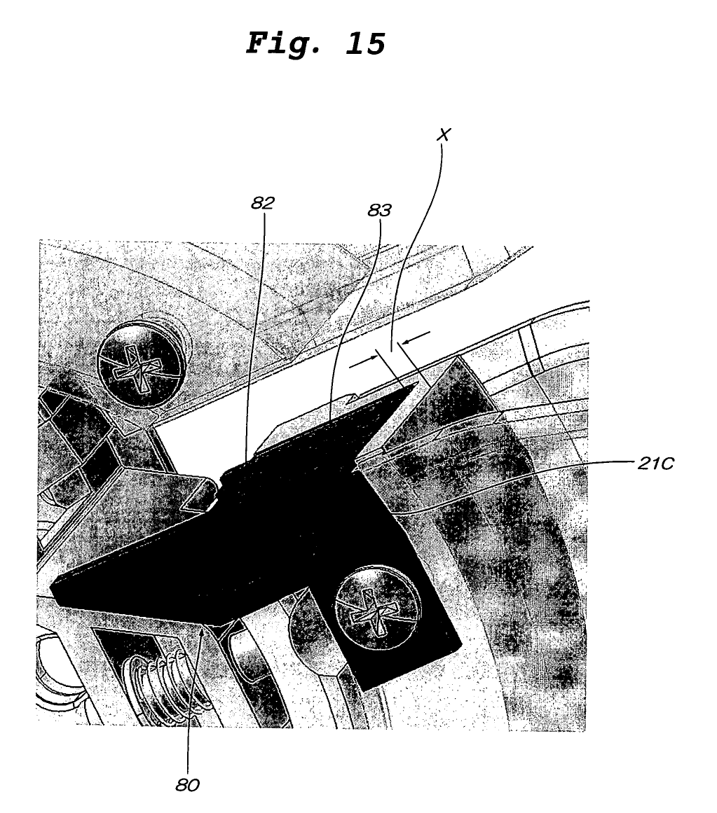

FIG. 13 is a perspective view of a positioning piece of the embodiment. FIG. 14 is a perspective view of a periphery of a hub opening of the embodiment in a state where the positioning piece is detached. FIG. 15 is a perspective view showing a state where the positioning piece is disposed.

The positioning piece 80 includes a reference surface 81 in the outer peripheral direction, and an opening-side side surface 82 intersecting with the reference surface 81 at right angles. The opening-side side surface 82 is formed with a rib 83 having a predetermined length. The rib 83 has two heights, and is formed in a direction matching with the inserting direction of the tape-pulling-out element 40. The positioning piece 80 includes a mounting piece 84 having a mounting hole with respect to the reel hub 21, and a ceiling surface 85 for positioning the tape-pulling-out element 40 in its height direction when the tape-pulling-out element 40 is inserted. The positioning piece 80 is integrally formed of resin material. Since the positioning piece 80 is the resin part and the tape-pulling-out element 40 is also the resin part, the friction force when they slide is reduced, galling can effectively be prevented.

The reel hub 21 forms the reference surface recess 21B in a side of the hub opening 21A by cutting from the inner peripheral surface of the reel hub 21 toward its outer peripheral surface. A reference surface 21C in the outer peripheral direction for limiting the distance from the outer peripheral surface of the reel hub 21 is formed on the side of the outer peripheral surface of the reel hub 21 of the reference surface recess 21B. A surface of the reference surface recess 21B which is adjacent to the reference surface 21C in the outer peripheral direction constitutes an opening width reference surface 21D which limits the width of the hub opening 21A. The reel hub 21 is made of metal material.

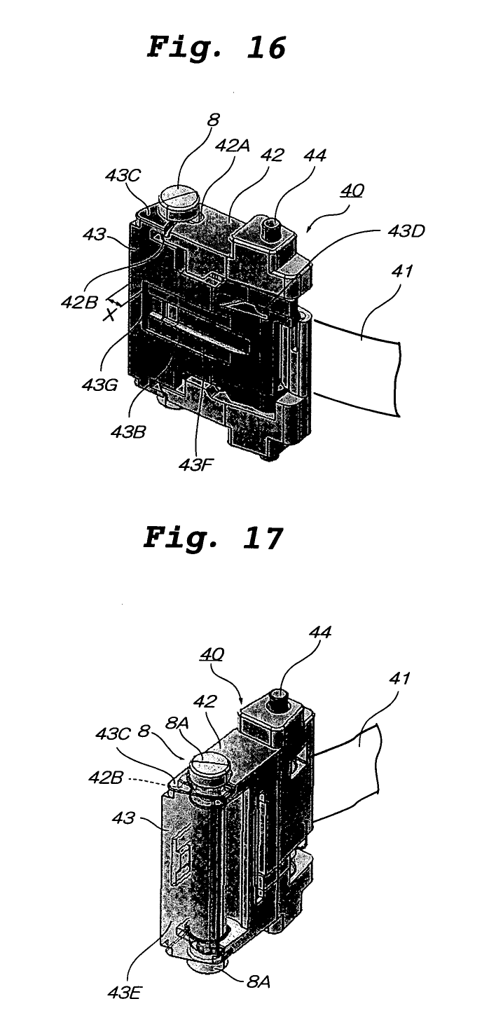

Next, the tape-pulling-out element of the embodiment will be explained using FIGS. 16 and 17.

FIG. 16 is a perspective view of a tape-pulling-out element. FIG. 17 is a perspective view of FIG. 16 as viewed from a different angle.

The first member 42 constituting the tape-pulling-out element 40 is provided at its one end with the turning shaft 44 which turns the second member 43, and at its other end with the pair of recesses 42A. A space in which the shaft of the coupling element 8 is disposed is formed between the pair of recesses 42A.

The second member 43 constituting the tape-pulling-out element 40 has the substrate 43B provided on the one side of the first member 42. One end of the substrate 43B is provided on the turning shaft 44 such that the end can turn through a predetermined angle. The other end of the substrate 43B includes the lid plate 43C extending at a predetermined angle with respect to the substrate 43B. The lid plate 43C is formed with a recess 43A on the side of the first member 42 (inner peripheral surface side), and a curved surface 43E is formed on the side opposite from the first member 42 (outer peripheral surface side). The curved surface 43E has the same curvature as that of the inner peripheral surface of the reel hub 21, and in a state where the tape-pulling-out element 40 is fitted into the hub opening 21A, the curved surface 43E constitutes a portion of the outer peripheral surface of the reel hub 21. The substrate 43B is provided with a resilient member 43D on the side of the turning shaft 44, and the resilient member 43D biases the second member 43 in a direction where the lid plate 43C closes the recess 42A of the first member 42. The substrate 43B is formed with a groove 43F having a predetermined length corresponding to the rib 83 of the positioning piece 80. Therefore, the groove 43F is formed in a direction matching with the inserting direction of the tape-pulling-out element 40 into the hub opening 21A. A stop wall 43G is formed on the side of a terminal end of the groove 43F. The stop wall 43G abuts against the abutment wall 83A of the rib 83 of the positioning piece 80. A size X (see FIG. 15) from the reference surface 21C in the outer peripheral direction to the outer peripheral surface of the reel hub 21 is the same as a distance X (see FIG. 16) from the stop wall 43G to the outer surface of the curved surface 43E. The area of the curved surface 43E of the tape-pulling-out element 40 is smaller than that of the outer peripheral surface (tape winding surface) of the reel hub 21, the distance X shown in FIG. 16 becomes shorter, and the distance X (see FIG. 15) between the cutting surface of the reference surface 21C in the outer peripheral direction and the outer peripheral surface of the reel hub 21 can be short. Therefore, the size management is easy, a step between the curved surface 43E of the tape-pulling-out element 40 and the outer peripheral surface of the reel hub 21 can be reduced as small as possible, and it is possible to prevent the tape from being damaged.

The shaft 8B of the coupling element 8 is provided at its both ends with enlarged portions 8A. The recess 42A and the recess 43A sandwich the shaft 8B while locating the enlarged portions 8A outward, thereby holding the coupling element 8. Even if the coupling element 8 is pulled from any direction, the tape-pulling-out element 40 holes the pulling-out element 8. That is, the coupling element 8 carries out tape threading while being always pulled toward the curved surface 43E, and the coupling element 8 is pressed by the recess 43A in a normal state. When an external force in the direction of the substrate 43B is applied to the coupling element 8, the coupling element 8 is held by the rib 42B provided on the lower portion of the recess 42A. Therefore, the second member 43 does not open as shown in FIGS. 12 and 14. The rib 42B projects toward the recess 43A at a location lower than the recess 42A by one step and is superposed on the recess 43A. When an external force in a direction opposite from the substrate 43B is applied to the coupling element 8, since the second member 43 is in the closing direction, the coupling element 8 is held. When an external force in the direction of the rotation shaft 44 is applied to the coupling element 8, the coupling element 8 is held in the recess 42A.

According to the embodiment, the reel hub 21 is made of metal material which can easily be machined, and the positioning piece 80 is made of resin material. With this, the size precision from the center of the reel hub 21 is not varied, and deviation between the reel hub 21 and the tape-pulling-out element 40 in the radial direction can be reduced.

According to the embodiment, since the positioning piece 80 is made of resin material and the tape-pulling-out element 40 is also made of resin material, the friction force when they slide is reduced, galling can effectively be prevented.

According to the embodiment, the reference surface recess 21B for disposing the positioning piece 80 is formed by cutting the reel hub 21 from its inner peripheral surface toward its outer peripheral surface. With this, the reference surface can be formed near the reel hub 21, and the positioning precision can be enhanced.

According to the embodiment, a deviation between the reel hub 21 and the tape-pulling-out element 40 in the radial direction can be reduced by the reference surface 21C in the outer peripheral direction.

According to the embodiment, the tape-pulling-out 40 element can stably be guided to a predetermined position by the rib 83 and the groove 43F having a predetermined length formed on or in the positioning piece 80 and the tape-pulling-out element 40.

According to the embodiment, sizes of the reel hub 21 and the tape-pulling-out element 40 in the radial direction can match with each other by this stop wall 43G.

According to the embodiment, the curved surface 43E of the second member 43 constitutes the curved surface shape having the same curvature as that of the outer peripheral surface of the reel hub 21, influence of distortion or bending by the resin material can be reduced.

Although the positioning piece 80 is provided with the rib 83 and the tape-pulling-out element 40 is provided with the groove 43F in this embodiment, a groove may be provided instead of the rib 83 and a rib may be provided instead of the groove 43F.

The magnetic recording/reproducing apparatus of this invention are suitable for an apparatus such as a linear type open system, and such apparatus is especially useful as a network tape storage.

1. A magnetic recording/reproducing apparatus in which an end of a tape accommodated in a tape cassette has a coupling element, and said coupling element is pulled out by a tape-pulling-out element and said tape is taken up around a drive reel, said magnetic recording/reproducing apparatus comprising
a leader tape having one end connected to a drive shaft of said drive reel and the other end connected to said tape-pulling-out element,
a reel hub which is located on an outer periphery of said drive shaft and which takes up said tape around an outer peripheral surface of said reel hub,
a hub opening which is provided on a portion of said reel hub and through which said leader tape passes, and
a positioning piece which is located in said hub opening and which positions said tape-pulling-out element, wherein
said reel hub is made of metal material, and said positioning piece is made of resin material.

2. The magnetic recording/reproducing apparatus according to claim 1, wherein
said hub opening is provided at its side with a reference surface recess formed by cutting said reel hub from its inner peripheral surface toward its outer peripheral surface, and said positioning piece is disposed in said reference surface recess.

3. The magnetic recording/reproducing apparatus according to claim 2, wherein
said reference surface recess constitutes a reference surface in an outer peripheral direction for limiting a distance from the outer peripheral surface of said reel hub.

4. The magnetic recording/reproducing apparatus according to claim 3, wherein
said positioning piece includes a reference surface corresponding to the reference surface in the outer peripheral direction, a side surface of said positioning piece on the side of opening which is perpendicular to said reference surface is formed with a rib or a groove having a predetermined length, and said rib or said groove is orientated in an inserting direction of said tape-pulling-out element.

5. The magnetic recording/reproducing apparatus according to claim 1, wherein
said positioning piece is formed with a rib or a groove having a predetermined length, said rib or said groove is orientated in an inserting direction of said tape-pulling-out element, and said tape-pulling-out element is formed at its side surface with a groove or a rib which corresponds to said rib or said groove.

6. The magnetic recording/reproducing apparatus according to claim 5, wherein
said tape-pulling-out element is provided at its side surface with a stop wall which abuts against said positioning piece.

7. The magnetic recording/reproducing apparatus according to claim 1, wherein
said tape-pulling-out element includes a first member formed with a recess, and a second member connected to said first member such that said second member can be displaced, said second member includes a lid plate on which said coupling element is mounted by closing said recess, an outer peripheral surface of said lid plate is formed with a curved surface, said curved surface has the same curvature as that of the outer peripheral surface of said reel hub, and said curved surface constitutes a portion of the outer peripheral surface of said reel hub in a state in which said tape-pulling-out element is fitted into said hub opening.
